(19) United States
(12) Patent Application Publication
(10) Pub. No.: US 2015/0128208 A1
(43) Pub. Date: May 7, 2015

(54) APPARATUS AND METHOD FOR DYNAMICALLY CONTROLLING SECURITY IN COMPUTING DEVICE WITH PLURALITY OF SECURITY MODULES

(71) Applicant: Electronics and Telecommunications Research Institute, Daejeon (KR)

(72) Inventors: Young-Ho KIM, Seoul (KR); Jeong-Nyeo KIM, Daejeon (KR); Hyun-Sook CHO, Daejeon (KR)

(73) Assignee: Electronics and Telecommunications Research Institute, Daejeon (KR)

(21) Appl. No.: 14/230,420

(22) Filed: Mar. 31, 2014

(30) Foreign Application Priority Data
Nov. 5, 2013 (KR) 10-2013-0133792

(51) Int. Cl. G06F 21/52

(52) U.S. Cl. CPC G06F 21/52
USPC 726/1

(57) ABSTRACT

Provided are an apparatus and method for dynamically controlling security of a computing device provided with a plurality of security modules. The apparatus includes a security policy storage unit configured to store a security policy that is set according to at least one of a state of the computing device and a characteristic of an application program executed on the computing device, and a dynamic calling control unit configured to recognize that a security function is called by the application program, and determine one of the plurality of security modules whose security function is to be called according to the set security policy.

### CROSS-REFERENCE TO RELATED APPLICATION

This application claims priority to and the benefit of Korean Patent Application No. 10-2013-0133792, filed on Nov. 5, 2013, the disclosure of which is incorporated herein by reference in its entirety.

### BACKGROUND

1. Field of the Invention

The present invention relates to an apparatus for dynamically controlling security of a computing device with a plurality of security modules and a method thereof, and more particularly, to an apparatus for dynamically calling a security function provided by a plurality of security modules implemented in hardware/software schemes in the computing device according to a security policy and a method thereof.

2. Discussion of Related Art

Nowadays, various computing devices, such as a mobile terminal, a desktop and a notebook computer, use a security module implemented in a hardware chip or a security module implemented in virtualization based software. When such a hardware security module or virtualized software security module is desired to be used in an application program, there is a need for programming using an additional software application programming interface (API) for connection with the security module.

Accordingly, once an application program has been implemented, the application program needs to be reprogrammed to adopt a new security module, which causes a limitation on the use of a new security module.

In this regard, there is a demand for technology allowing existing application programs to use a new security module applied to a device without reprogramming the application programs. Further, there is a demand for technology allowing an application program to easily use a security module provided by a terminal on which the program is executed, even when an application developer develops the program regardless of a security environment of the terminal in a development stage, that is, regardless of whether or not a hardware security module or a virtualization based software security module is installed on the terminal.

### SUMMARY OF THE INVENTION

The present invention is directed to technology capable of ensuring high security provided by a security module installed on a computing device even when an application developer develops a program regardless of an environment of the computing device on which the program is to be executed in practice.

The present invention is directed to technology capable of dynamically controlling security for a program according to an environment of a computing device and a security policy (an access control policy) without reprogramming the existing program when a new hardware based security module is installed on the computing device providing a security function using existing software/hardware safety modules.

According to an aspect of the present invention, there is provided an apparatus for dynamically controlling security of a computing device provided with a plurality of security modules, the apparatus including: a security policy storage unit configured to store a security policy that is set according to at least one of a state of the computing device and a characteristic of an application program executed on the computing device; and a dynamic calling control unit configured to recognize that a security function is called by the application program, and according to the set security policy, determine one of the plurality of security modules whose security function is to be called.

According to another aspect of the present invention, there is provided a computing device whose security is dynamically controlled the computing device including: a plurality of security modules; a processor; and a memory comprising instructions that are executed by the processor. When the instructions are executed by the processor, the instructions may allow the processor to store a security policy that is set according to at least one of a state of the computing device and a characteristic of an application program executed on the computing device, and in response to the application program calling a security function, allow the processor to determine one of the plurality of security modules whose security function is to be called, according to the set security policy.

According to still another aspect of the present invention, there is provided a method of dynamically controlling security of a computing device provided with a plurality of security modules, the method including: storing a security policy that is set according to at least one of a state of the computing device and a characteristic of an application program executed on the computing device; recognizing that a security function is called by the application program, and determining, in response to calling of a security function, one of the plurality of security modules whose security function is to be called, according to the set security policy.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a schematic view illustrating a structure of a computing device using a security control apparatus according to an exemplary embodiment of the present invention.

FIG. 2 is a schematic view illustrating a process of dynamically calling a key generation function KeyGen( ) by an application program according to an exemplary embodiment of the present invention.

FIG. 3 is a flowchart showing a method of dynamically controlling security of a computing device provided with a plurality of security modules according to an exemplary embodiment of the present invention.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

Description of techniques, which have been widely known in the related technical field and not directly related with the present invention, are omitted to make essential points of the present invention clear by omitting unnecessary description.

In the present specification and claims, the denoting of “a unit” may be used to refer to one or more units unless specifically noted otherwise.

In the present specification, the terms “module,” “unit” and “interface” in general represent computer related objects, and may represent, for example, hardware, software and a combination of these.

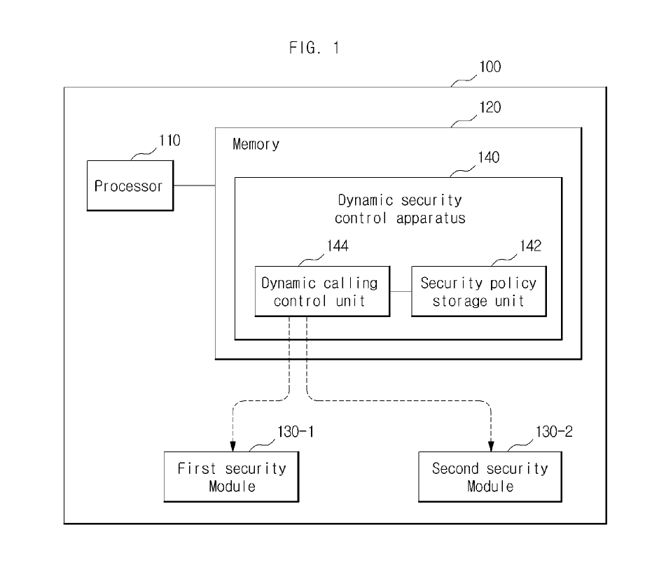

FIG. 1 is a schematic view illustrating a structure of a computing device using a security control apparatus according to an exemplary embodiment of the present invention.

Referring to FIG. 1, a computing device 100 includes a processor 110 and a memory 120, in addition to a first security module 130-1 and a second security module 130-2, and a dynamic security control apparatus 140 is stored in the memory 120 in the form of instructions for dynamically controlling security of the computing device 100 by selectively using the first and second security modules 130-1 and 130-2.

Although FIG. 1 illustrates two security modules for the sake of convenience of the description, the number of security modules according to the present invention is not limited thereto.

According to an exemplary embodiment of the present invention, the first security module 130-1 is a virtualization based software security module, that is, a module implemented in the form of a security function library, and the second security module 130-2 is a hardware security module implemented in the form of a hardware chip. In general, the second security module 130-2 implemented in the hardware chip provides the computing device with higher security than the first security module 130-1 implemented in software.

According to an exemplary embodiment of the present invention, the dynamic security control apparatus 140 may include a security policy storage unit 142 and a dynamic calling control unit 144.

The security policy storage unit 142 stores a security policy that is set according to at least one of a state of the computing device 100 and a characteristic of an application program executed on the computing device 100. According to an exemplary embodiment of the present invention, the security policy may be directly set by a user of the computing device 100. Alternatively, the security policy may be remotely set and/or changed through an external administration server by an administrator who manages the device. Accordingly, from the viewpoint of a business managing a computing device, the security of the computing device is dynamically controlled depending on various security policies.

The security policy represents information for setting a security level that is to be provided with respect to a state of the computing device 100 and a certain application program executed on the computing device 100. According to the security policy, a security module whose security function is to be called is determined. According to an exemplary embodiment of the present invention, the security policy may include a security level set differently depending on a state of the computing device 100 (for example, usable inside/outside an office or trusted terminal/non-trusted terminal) and/or a characteristic of an application program (for example, a business program requiring high level security/a business program requiring middle level security/a personal program). For example, when a business program requiring high security is executed on the computing device 100 outside an office, the security level is set to a highest level, and when a personal program is executed, the security of the personal program is secured only with a software security module, so that the security level is set to a low level.

The dynamic calling control unit 144 recognizes that a security function is called by an application program, and according to the security policy stored in the security policy storage unit 142, determines one of the plurality of security modules 131-1 and 131-2 whose security function is to be called. It is obvious to the those skilled in the art that the dynamic calling control unit 144 may be implemented in the form of a library providing the same interface to various application programs, and may implement invocation of a security function in the form of a function pointer that may jump to one of security functions provided by the plurality of security modules.

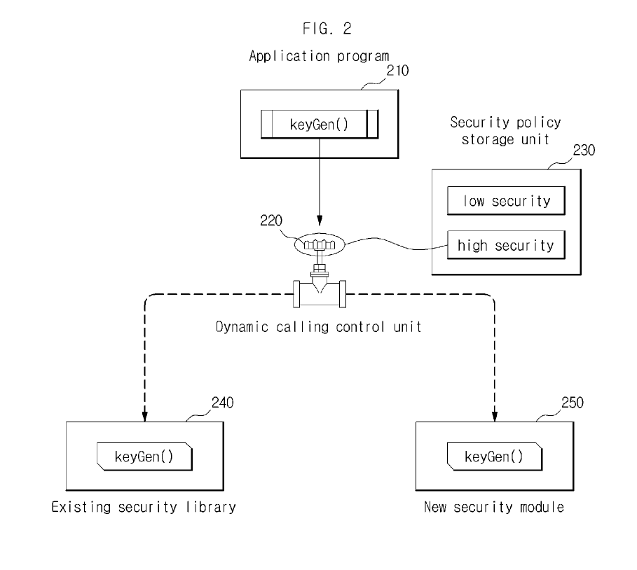

FIG. 2 describes a process of calling an actual function when an application program calls a key generation function KeyGen( )according to an exemplary embodiment of the present invention.

Referring to FIG. 2, it is assumed that an application program 210 calls a key generation function KeyGen( ). The application program 210 is a program developed before a new security module 250 is installed on a computing device, and is programmed to call a key generation function KeyGen( ) provided by an existing security library 240. However, according to an exemplary embodiment of the present invention, it is determined by a dynamic calling control unit 220 which one of a key generation function KeyGen( ) provided by the existing security library 240 and a key generation function KeyGen( ) provided by the new security module 250 is to be called based on a security policy stored in a security policy storage unit 230. If a security policy with respect to the application program is stored as low security in the security policy storage unit 230, a KeyGen( ) in the existing security library 240 is called upon calling a key generation function. However, if a security policy with respect to the application program is stored as high security in the security policy storage unit 230, a KeyGen( ) in the new security module 250 is called, thereby enabling a security key to be generated in a safer manner.

As described above, in an exemplary embodiment of the present invention, the security function called by an application program is not actually determined by a program developer when the application program is developed by a program developer, but by a user of the computing device or an administrator (a server) remotely managing the computing device through a dynamic setting of the security policy. The developer of an application program may develop a program regardless of a new security module that will be released in the future, and even when a new security module is applied to a computing device, the compatibility is maintained without modifying the existing program.

As another example of applying the security control according to the present invention to an actual service environment, the security control may be implemented with respect to a case of Bring Your Own Device (BYOD), such as when a mobile terminal is used for business purposes and personal purposes. When a user uses a mobile terminal for business purposes at work, and an application program calls a store function store( ) to store business data, the business data may be configured to be stored in a hardware security module installed on the mobile terminal, according to a security policy set to a high security level. Meanwhile, when a user stores personal data by using the application program out of the office after work, the personal data may be stored by use of the existing security library in a separate form from the business data according to a security level that is set to a low security level since high security is not necessary. As such, the present invention provides benefits enabling the developer of an application program to develop a program through the same interface at all times, and also provides a method for allowing a user of a computing device or a business managing a computing device to safely maintain a computing device according to various security policies.

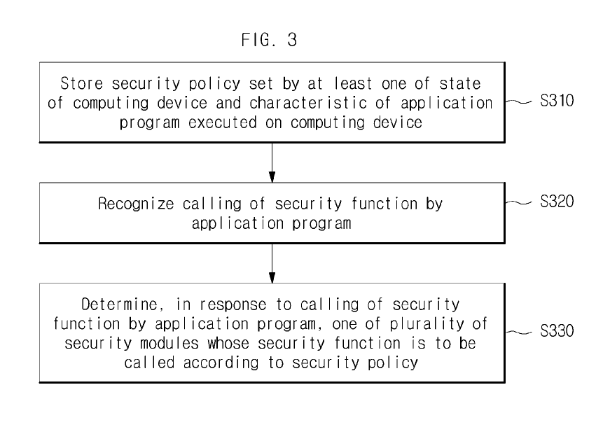

FIG. 3 is a flowchart showing a method of dynamically controlling security of a computing device provided with a plurality of security modules according to an exemplary embodiment of the present invention.

A security policy that is dynamically set by at least one of a state of a computing device and a characteristic of an application program executed on the computing device is stored (S310).

According to an exemplary embodiment of the present invention, the security policy may include security level information with respect to the application program executed on the computing device 100, in which the application program may include a plurality of application programs.

According to an exemplary embodiment of the present invention, the security policy may be directly set by a user of the computing device, or remotely set and/or changed by an administrator through an external administration server.

It is recognized that a security function is called by the application program (S320).

In response to the calling of the security function by the application program, one of the plurality of security modules whose security function is to be called is determined according to the security policy (S330).

According to an exemplary embodiment of the present invention, the plurality of security modules may include a security library implemented in software and a hardware security module.

As described above, the present invention can allow a previously written application program to call a hardware based security module or a virtualization based security module without changing a source code when a computing device has the hardware based security module or the virtualization based security module installed therein to enhance the security thereof. Accordingly, compatibility with an existing program is provided while enhancing the security that is originally intended through a newly added security module.

The disclosure can be embodied as program instructions executable through various computing devices and can be recorded in a computer readable medium. The computer readable medium may include a program instruction, a data file and a data structure or a combination of one or more of these.

The program instruction recorded in the computer readable medium may be specially designed for the present invention or generally known in the art to be available for use. Examples of the computer readable recording medium include a hardware device constructed to store and execute a program instruction, for example, magnetic media such as hard disks, floppy disks, and magnetic tapes, optical media such as CD-ROMs, and DVDs, and magneto-optical media such as floptical disks, read-only memories (ROMs), random access memories (RAMs), and flash memories. In addition, the above described medium may be a transmission medium such as light including a carrier wave transmitting a signal specifying a program instruction and a data structure, a metal line and a wave guide. The program instruction may include a machine code made by a compiler, and a high-level language executable by a computer through an interpreter.

The above described hardware device may be constructed to operate as one or more software modules to perform the operation of the present invention, and vice versa.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. An apparatus for dynamically controlling security of a computing device provided with a plurality of security modules, the apparatus comprising:
a security policy storage unit configured to store a security policy that is set according to at least one of a state of the computing device and a characteristic of an application program executed on the computing device; and
a dynamic calling control unit configured to recognize that a security function is called by the application program, and determine one of the plurality of security modules whose security function is to be called according to the set security policy.

2. The apparatus of claim 1, wherein the security policy stored in the security policy storage unit comprises security level information of the application program.

3. The apparatus of claim 1, wherein the security policy is remotely changeable by an administrator through an external administration server.

4. The apparatus of claim 1, wherein the plurality of security modules comprise a security library implemented using software and a hardware security module.

5. The apparatus of claim 1, wherein, even when the application program calls a security function provided by the security library, a security function provided by the hardware security module is able to be called according to the determination of the dynamic calling control unit.

6. A computing device comprising:
a plurality of security modules;
a processor; and
a memory comprising instructions that are executed by the processor,
wherein, when the instructions are executed by the processor, the instructions allow the processor to store a security policy that is set according to at least one of a state of the computing device and a characteristic of an application program executed on the computing device, and in response to the application program calling a security function, allow the processor to determine one of the plurality of security modules whose security function is to be called according to the set security policy.

7. A method of dynamically controlling security of a computing device provided with a plurality of security modules, the method comprising:
storing a security policy that is set according to at least one of a state of the computing device and a characteristic of an application program executed on the computing device;
recognizing that a security function is called by the application program, and determining, in response to calling of a security function, one of the plurality of security modules whose security function is to be called according to the set security policy.

8. The method of claim 7, wherein the security policy includes security level information of the application program.

9. The method of claim 7, wherein the security policy is remotely changeable by an administrator through an external administration server.

10. The method of claim 7, wherein the plurality of security modules comprises a security library implemented using software and a hardware security module.
